(19) United States
(12) Patent Application Publication
(10) Pub. No.: US 2026/0144247 A1
(43) Pub. Date: May 28, 2026

(54) DECOY RIGGING SYSTEM AND METHOD

(71) Applicant: Paul Vincent Lopez, II, Clear Lake, IA (US)

(72) Inventor: Paul Vincent Lopez, II, Clear Lake, IA (US)

(21) Appl. No.: 19/399,781

(22) Filed: Nov. 25, 2025

Related U.S. Application Data
(60) Provisional application No. 63/725,674, filed on Nov. 27, 2024.

(51) Int. Cl. A01M 31/06

(52) U.S. Cl. CPC A01M 31/06

(57) ABSTRACT

In one or more arrangements, a decoy rigging system is presented. In one or more arrangements, the decoy rigging system includes a decoy, a rig line and a rig. In one or more arrangements, the rig line has a first end and a second end with a stopper. In one or more arrangements, the rig has a top side, a bottom side, and an aperture extending vertically through the rig. In one or more arrangements, the first end of the rig line is configured to connect to the decoy and the rig extends through the aperture of the rig and outward from the bottom side of the rig. In one or more arrangements, the stopper on the second end of the rig line prevents the rig line and the rig from becoming disconnected. In this arrangement, the rig prevents the decoy from moving when in use.

### CROSS-REFERENCE TO RELATED APPLICATIONS

This application claims priority to U.S. Provisional Application 63/725,674, titled “DECOY RIGGING SYSTEM AND METHOD”, and filed Nov. 27, 2024, the entirety of which is hereby incorporated by reference herein, including any figures, tables, drawings, or other information.

### FIELD OF THE DISCLOSURE

This disclosure relates to a decoy rigging system and method of use. More specifically, this disclosure relates to a mushroom weight decoy rigging system and method of use.

### OVERVIEW OF THE DISCLOSURE

When hunting waterfowl, such as ducks, mallards, and other waterfowl, decoys which resemble such waterfowl are placed in areas near the spot where the hunter is located in order to attract real waterfowl to land at or near that location. Oftentimes, waterfowl decoys are placed in shallow water and the decoys must be anchored in the water so they do not move away from the desired location. In order to do so, a decoy rigging system is used which typically consists of a rig line and a rig (sometimes also called an anchor).

Typical rigs include a hole which extends horizontally through the top of the rig. This horizontal hole allows the rig line to pass through the rig, thereby operably connecting the rig to the decoy. This horizontal hole in the top of the rig does not allow the rig to easily and efficiently slide down the rig line. Often times, the rig gets caught up or snagged on the rig line as it moves down the rig line, which requires the user to have to get the rig unstuck so that it can continue down the rig line until it reaches the bottom of the body of water where the decoy is located. This causes hassle and extends set up time and effort exerted by the user in setting up decoys when the user could be hunting. Especially where the user is setting up a number of decoys at various positions near the desired location (which is typically the case) this inefficient sliding of rig down the rig line can add up and significantly increase set up time.

Therefore, for all the reasons stated above, and the reasons stated below, there is a need in the art for an improved decoy rigging system which can anchor a decoy when in use. Thus, it is a primary objective of the disclosure to provide a decoy rigging system and method of use that improves upon the state of the art.

Another objective of the disclosure is to provide a decoy rigging system which is safe to operate.

Yet another objective of the disclosure is to provide a decoy rigging system which is relatively easy to build.

Another objective of the disclosure is to provide a decoy rigging system which is relatively friendly to build.

Yet another objective of the disclosure is to provide a decoy rigging system which can be built relatively quickly and efficiently.

Another objective of the disclosure is to provide a decoy rigging system which is easy to operate.

Yet another objective of the disclosure is to provide a decoy rigging system which is relatively cost friendly to manufacture.

Another objective of the disclosure is to provide a decoy rigging system which is relatively easy to transport.

Yet another objective of the disclosure is to provide a decoy rigging system which is aesthetically appealing.

Another objective of the disclosure is to provide a decoy rigging system which is robust.

Another objective of the disclosure is to provide a decoy rigging system which is relatively inexpensive.

Yet another objective of the disclosure is to provide a decoy rigging system which is not easily susceptible to wear and tear.

Another objective of the disclosure is to provide a decoy rigging system which has a long useful life.

Yet another objective of the disclosure is to provide a decoy rigging system which is efficient to use and operate.

These and other objects, features, or advantages of the disclosure will become apparent from the specification, figures, and claims.

### SUMMARY OF THE DISCLOSURE

In one or more arrangements, a decoy rigging system is presented. In one or more arrangements, the decoy rigging system includes a decoy, a rig line and a rig. In one or more arrangements, the rig line has a first end and a second end with a stopper. In one or more arrangements, the rig has a top side, a bottom side, and an aperture extending vertically through the rig. In one or more arrangements, the first end of the rig line is configured to connect to the decoy and the rig extends through the aperture of the rig and outward from the bottom side of the rig. In one or more arrangements, the stopper on the second end of the rig line prevents the rig line and the rig from becoming disconnected. In this arrangement, the rig prevents the decoy from moving when in use.

### BRIEF DESCRIPTION OF THE FIGURES

FIG. 1 shows a side view of a conventional decoy rigging system.

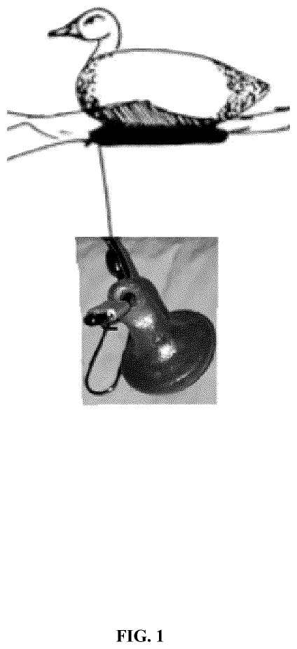

FIG. 2 shows a cross-section view of a rig of a conventional decoy rigging system.

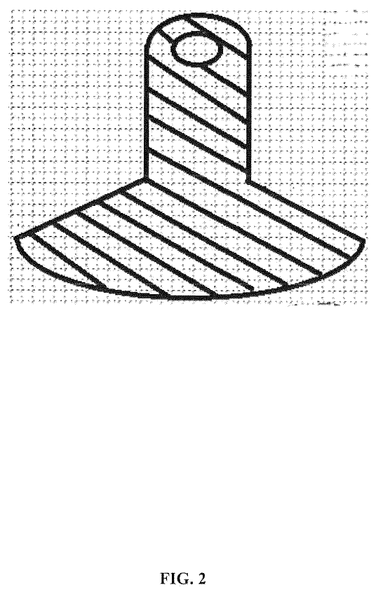

FIG. 3 shows a side view of a decoy rigging system, in accordance with one or more arrangements; the view showing the system having a decoy, a rig line attached to the decoy, and a rig attached thereto.

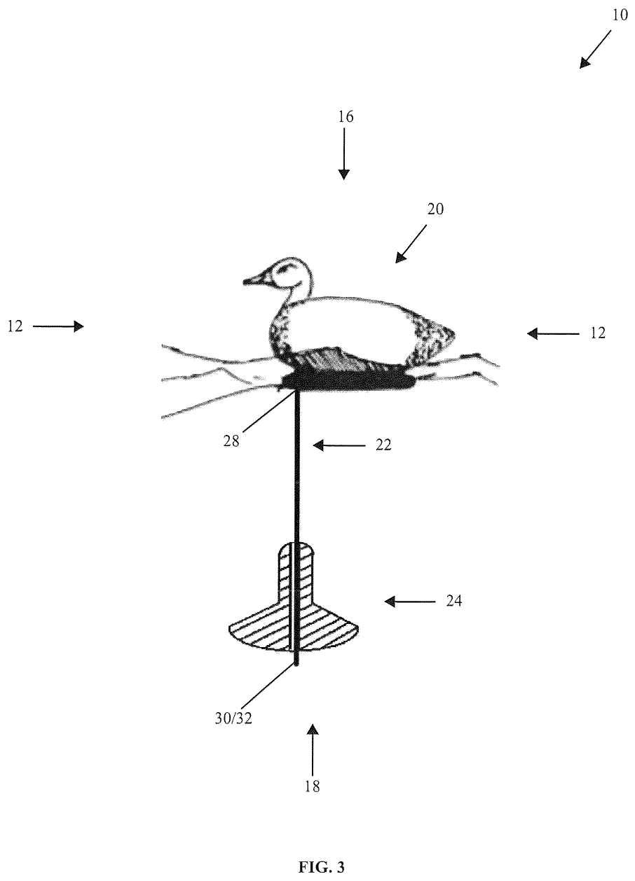

FIG. 4 shows an upper isometric view of a rig of a decoy rigging system, in accordance with one or more arrangements; the view showing the rig having a stem portion, a base portion, and an aperture extending through the stem portion and base portion.

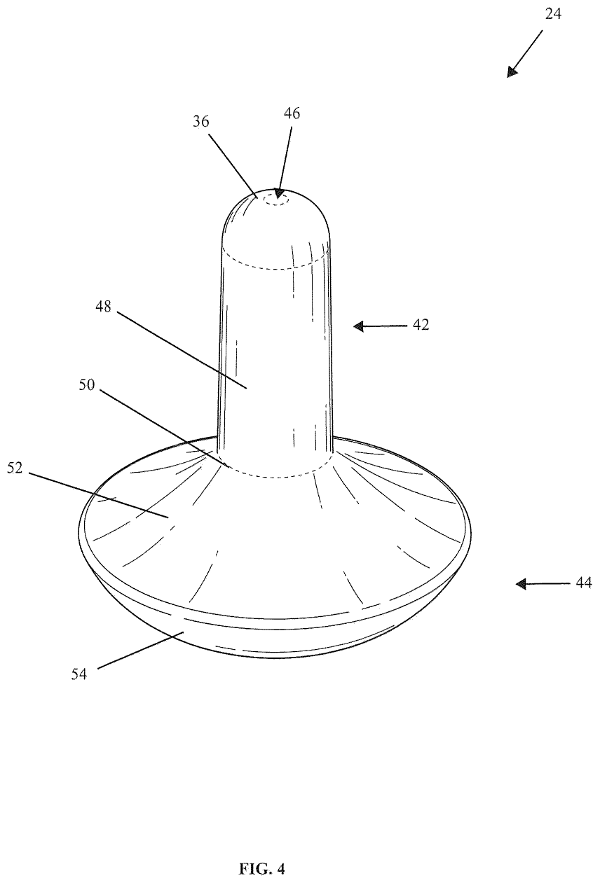

FIG. 5 shows a side elevation view of a rig of a decoy rigging system, in accordance with one or more arrangements; the view showing the rig having a stem portion and a base portion.

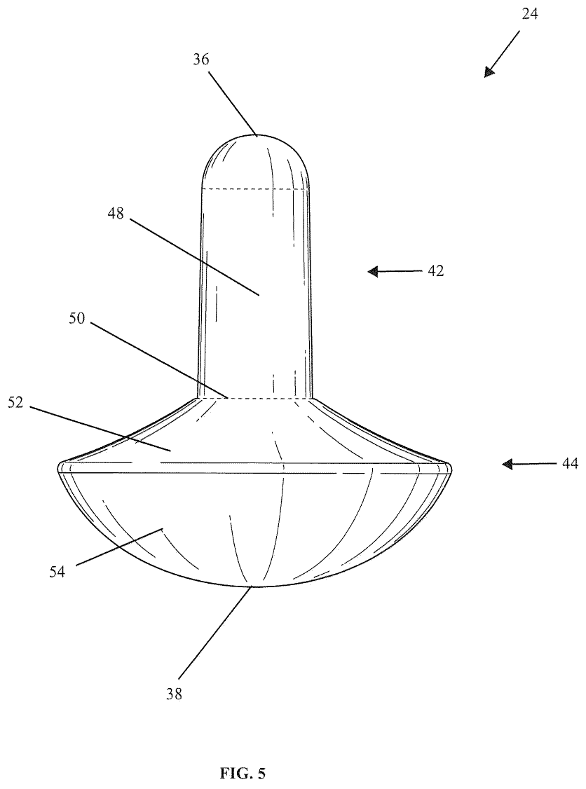

FIG. 6 shows a top elevation view of a rig of a decoy rigging system, in accordance with one or more arrangements; the view showing the rig having a stem portion, a base portion, and an aperture extending through the stem portion and base portion.

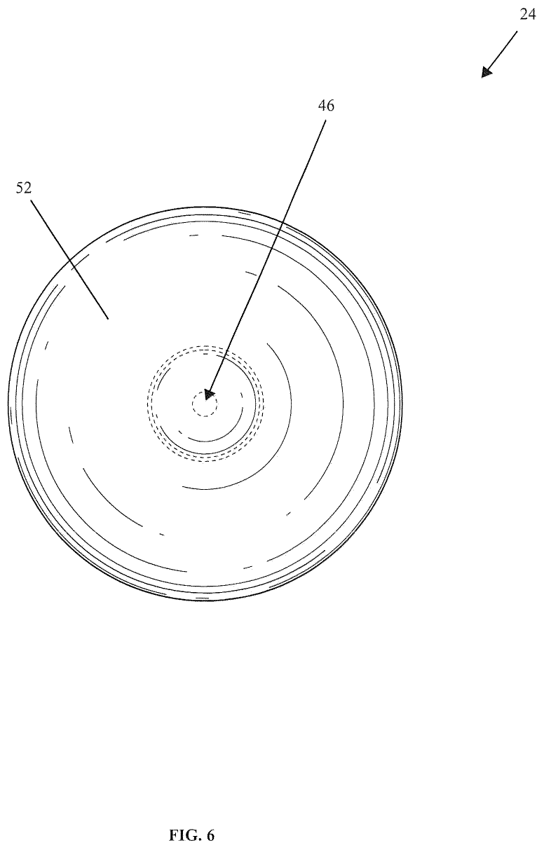

FIG. 7 shows a bottom elevation view of a rig of a decoy rigging system, in accordance with one or more arrangements; the view showing the rig having a base portion and an aperture extending through the base portion.

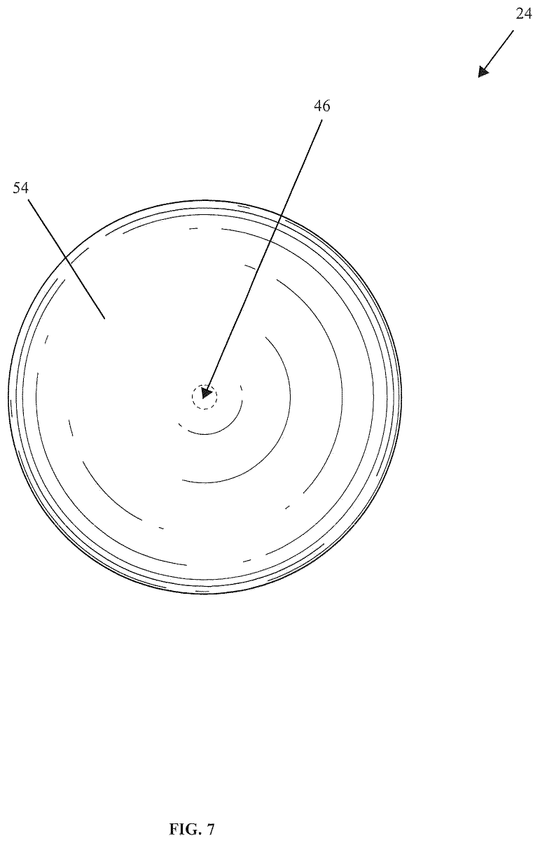

FIG. 8 shows a lower isometric view of a rig of a decoy rigging system, in accordance with one or more arrangements; the view showing the rig having a stem portion, a base portion, and an aperture extending through the stem portion and base portion.

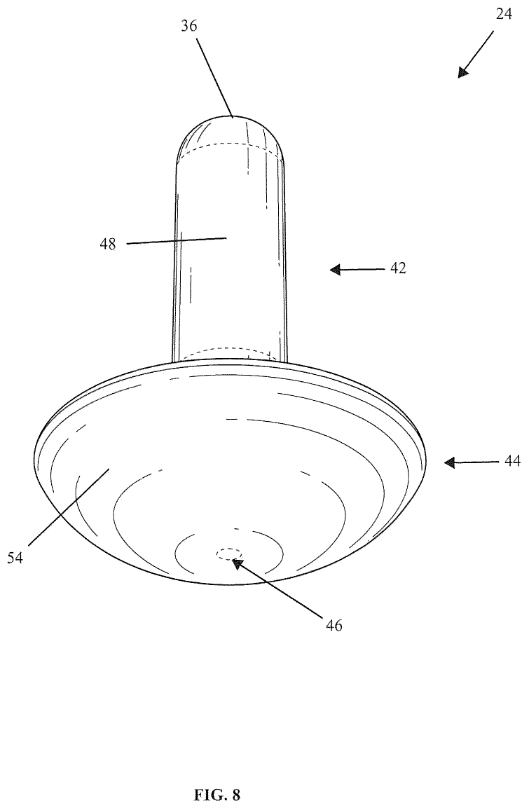

FIG. 9 shows a side elevation view of a rig of a decoy rigging system, in accordance with one or more arrangements; the view showing the rig having a stem portion, a base portion, and an aperture extending through the stem portion and base portion.

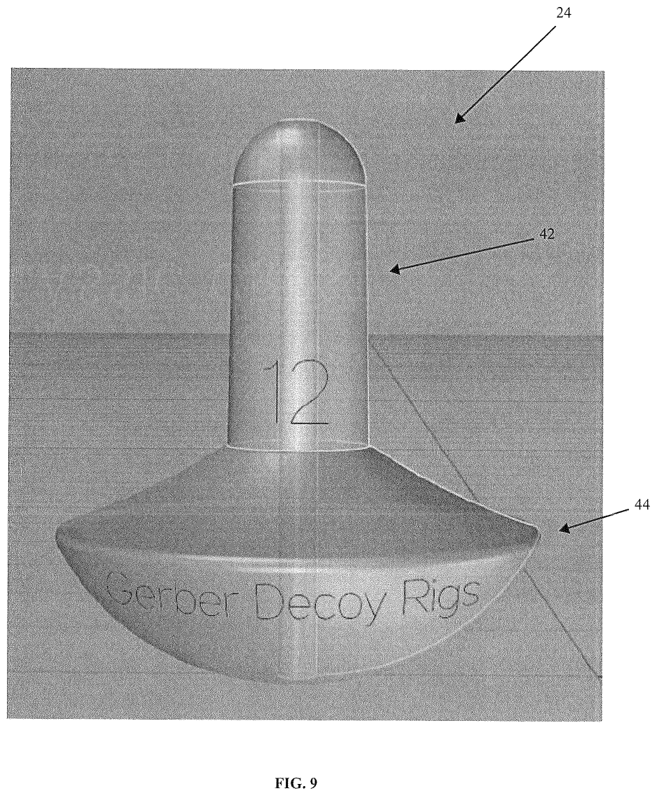

FIG. 10 shows a side elevation view of a rig of a decoy rigging system, in accordance with one or more arrangements; the view showing the rig having a stem portion and a base portion.

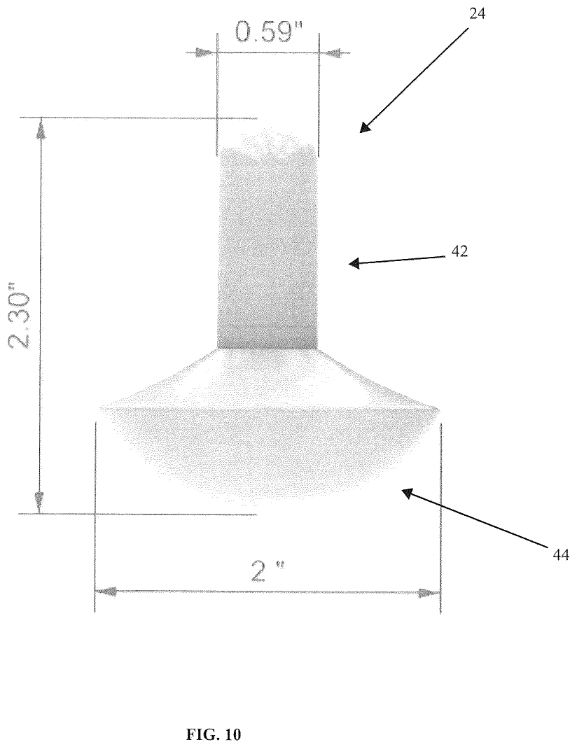

FIG. 11 shows a side elevation view of a rig of a decoy rigging system, in accordance with one or more arrangements; the view showing the rig having a stem portion and a base portion.

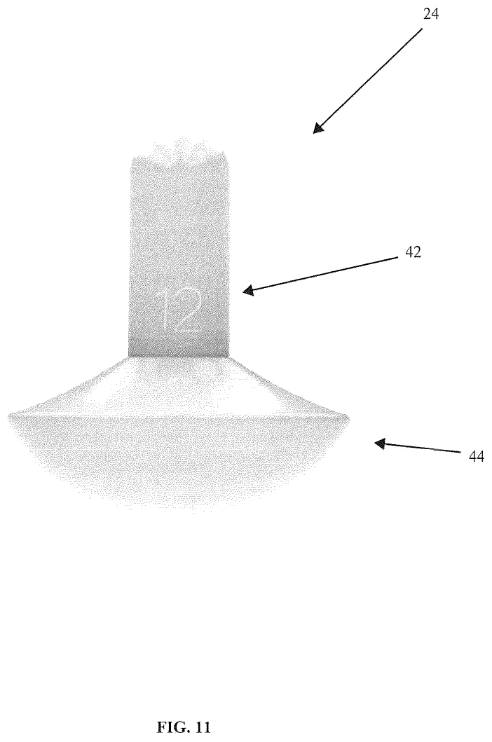

FIG. 12 shows a side isometric view of a rig of a decoy rigging system, in accordance with one or more arrangements; the view showing the rig having a stem portion and a base portion.

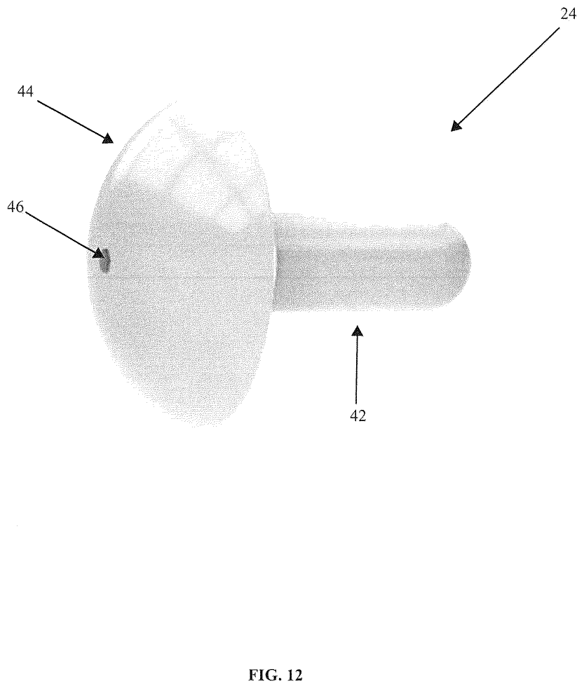

FIG. 13 shows a side isometric view of a rig of a decoy rigging system, in accordance with one or more arrangements; the view showing the rig having a stem portion and a base portion.

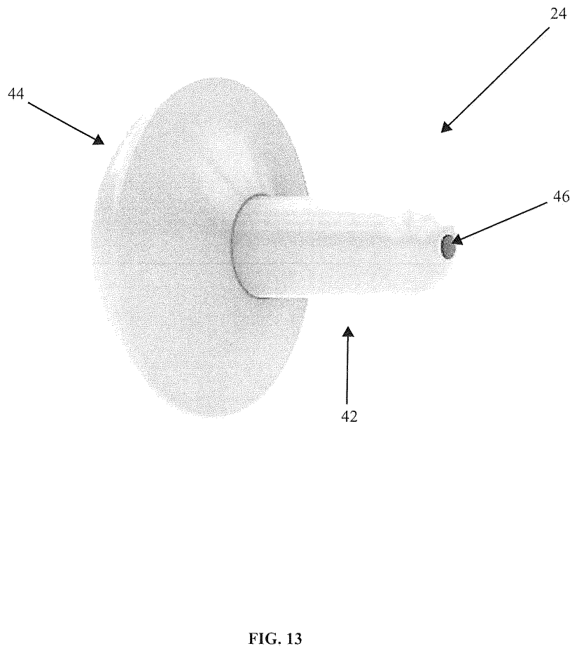

FIG. 14 shows a side cross-section view of a rig of a decoy rigging system, in accordance with one or more arrangements; the view showing the rig having a stem portion, a base portion, and an aperture extending through the stem portion and base portion.

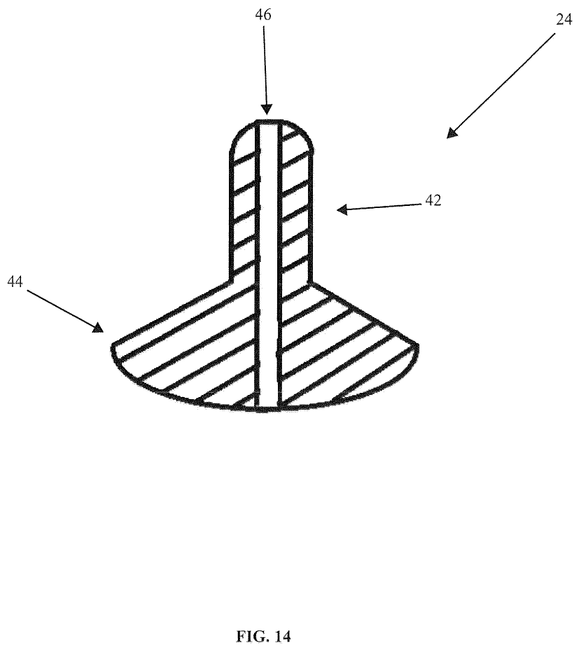

FIG. 15 shows a side cross-section view of a rig of a decoy rigging system, in accordance with one or more arrangements; the view showing the rig having a stem portion, a base portion, and an aperture extending through the stem portion and base portion.

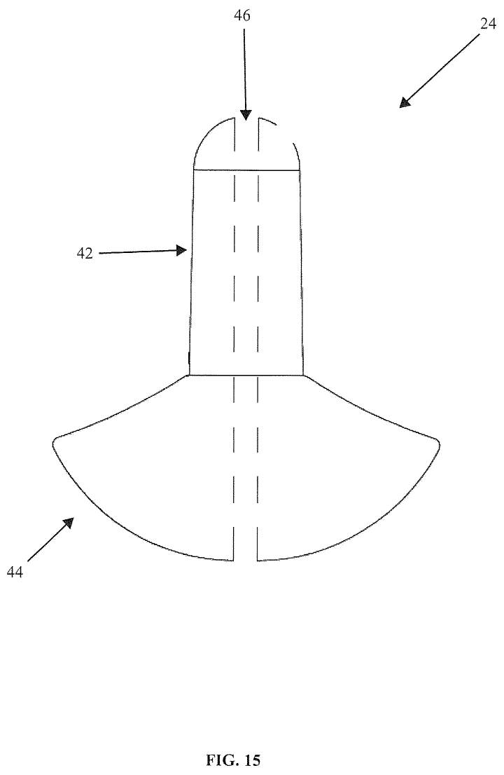

FIG. 16 shows a bottom elevation view of a rig of a decoy rigging system, in accordance with one or more arrangements; the view showing the rig having a base portion and an aperture extending through the base portion.

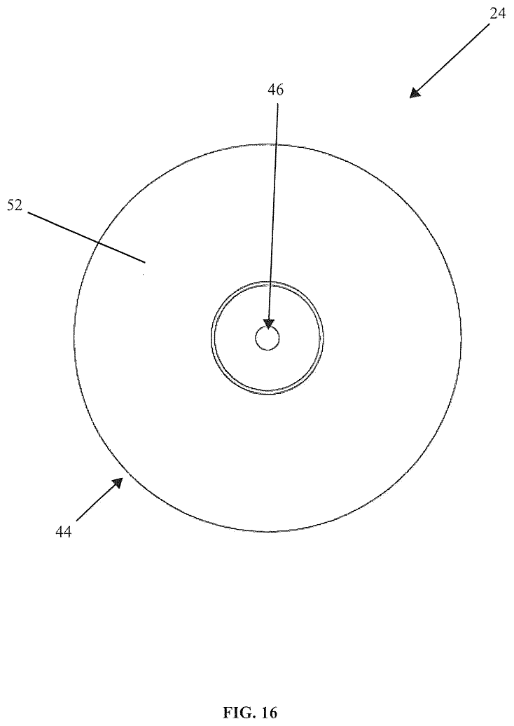

FIG. 17 shows a side elevation view of a decoy rigging system, in accordance with one or more arrangements; the view showing the decoy rigging system having a rig, a rig line, and a swivel attached thereto.

### DETAILED DESCRIPTION OF THE DISCLOSURE:

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in or described with reference to certain figures or embodiments, it will be appreciated that features from one figure or embodiment may be combined with features of another figure or embodiment even though the combination is not explicitly shown or explicitly described as a combination. In the depicted embodiments, like reference numbers refer to like elements throughout the various drawings.

It should be understood that any advantages and/or improvements discussed herein may not be provided by various disclosed embodiments, or implementations thereof. The contemplated embodiments are not so limited and should not be interpreted as being restricted to embodiments which provide such advantages or improvements. Similarly, it should be understood that various embodiments may not address all or any objects of the disclosure or objects of the invention that may be described herein. The contemplated embodiments are not so limited and should not be interpreted as being restricted to embodiments which address such objects of the disclosure or invention. Furthermore, although some disclosed embodiments may be described relative to specific materials, embodiments are not limited to the specific materials or apparatuses but only to their specific characteristics and capabilities and other materials and apparatuses can be substituted as is well understood by those skilled in the art in view of the present disclosure.

It is to be understood that the terms such as “left, right, top, bottom, front, back, side, height, length, width, upper, lower, interior, exterior, inner, outer, and the like as may be used herein, merely describe points of reference and do not limit the present invention to any particular orientation or configuration. As used herein, “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components,

and/or groups thereof, unless expressly indicated otherwise. For example, if an embodiment of a system is described as comprising an article, it is understood the system is not limited to a single instance of the article unless expressly indicated otherwise, even if elsewhere another embodiment of the system is described as comprising a plurality of articles.

It will be understood that when an element is referred to as being “connected,” “coupled,” “mated,” “attached,” “fixed,” etc. to another element, it can be directly connected to the other element, and/or intervening elements may be present. In contrast, when an element is referred to as being “directly connected,” “directly coupled,” “directly engaged” etc. to another element, there are no intervening elements present. Other words used to describe the relationship between elements should be interpreted in a like fashion (e.g., “between” versus “directly between,” “adjacent” versus “directly adjacent,” “engaged” versus “directly engaged,” etc.). Similarly, a term such as “operatively” or “operably”, such as when used as “operatively connected” or “operably engaged” is to be interpreted as connected or engaged, respectively, in any manner that facilitates operation, which may include being directly connected, indirectly connected, electronically connected, wirelessly connected or connected by any other manner, method or means that facilitates desired operation. Similarly, a term such as “communicatively connected” includes all variations of information exchange and routing between two electronic devices, including intermediary devices, networks, etc., connected wirelessly or not. Similarly, “connected” or other similar language particularly for electronic components is intended to mean connected by any means, either directly or indirectly, wired and/or wirelessly, such that electricity and/or information may be transmitted between the components.

It will be understood that, although the ordinal terms “first,” “second,” etc. may be used herein to describe various elements, these elements should not be limited to any order by these terms unless specifically stated as such. These terms are used only to distinguish one element from another; where there are “second” or higher ordinals, there merely must be a number of elements, without necessarily any difference or other relationship. For example, a first element could be termed a second element, and, similarly, a second element could be termed a first element, without departing from the scope of example embodiments or methods.

Similarly, the structures and operations discussed herein may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, to provide looping or other series of operations aside from single operations described below. It should be presumed that any embodiment or method having features and functionality described below, in any workable combination, falls within the scope of example embodiments.

As used herein, various disclosed embodiments may be primarily described in the context of hunting decoys. However, the embodiments are not so limited. It is appreciated that the embodiments may be adapted for use in other applications which may be improved by the disclosed structures, arrangements and/or methods. The system is merely shown and described as being used in the context of hunting decoys for ease of description and as one of countless examples.

### Decoy Rigging System

With reference to the figures, a decoy rigging system 10 (or simply “system 10”) is presented. System 10 is formed of any suitable size, shape, and design and is configured to keep a decoy, such as a duck decoy used for duck hunting, in place at the surface of a body of water. In the arrangement shown, as one example, system 10 has an opposing front and back ends 12 (or simply “ends 12”), opposing left and right sides (or simply “sides”), a top side 16, and a bottom side 18. In the arrangement shown, as one example, system 10 includes a decoy 20, a rig line 22, a rig 24, and a swivel 26, among other components as is described herein. While system 10 has been described according to the arrangement shown, as one example, any combination or arrangement may be used and is hereby contemplated for use.

### Decoy 20

In the arrangement shown, as one example, system 10 includes decoy 20. Decoy 20 is formed of any suitable size, shape, and design and is configured to appear to other animals as an animal of the same species such as, by way of example and not a limitation, a duck or other waterfowl. In the arrangement shown, as one example, decoy 20 is a duck or other waterfowl decoy. In one or more arrangements, decoy 20 may be any decoy typically sold in the hunting and sporting goods market or otherwise used by hunters. In the arrangement shown, as one example, decoy 20 is a duck decoy configured to be placed in water to simulate a duck in the water. In the arrangement shown, as one example, decoy 20 must be anchored in place so that the decoy 20 does not float away in waves or blow away with wind. In order to anchor decoy 20 in place, system 10 includes rig 24 which is connected to decoy 20 by rig line 22.

### Rig Line 22

In the arrangement shown, as one example, system 10 includes rig line 22. Rig line 22 is formed of any suitable size, shape, and design and is configured to operably connect decoy 20 and rig 24. In the arrangement shown, as one example, rig line 22 is a cable which extends between a first end 28 and a second end 30 and includes a stopper 32 at second end 30.

In the arrangement shown, as one example, rig line 22 is formed of a single, unitary member that is formed in a manufacturing process such as extrusion, machining, additive manufacturing, or the like. Alternatively, rig line 22 may be formed of multiple pieces that are connected or assembled to one another through any means of connecting or assembling the multiple pieces such as adhesion, welding, or the like. In the arrangement shown, as one example, rig line 22 is formed primarily of a metallic material such as steel, aluminum, chromium, or any other metallic material, alloy, and/or composite thereof. Alternatively, rig line 22 may be formed of a non-metallic material such as a plastic material, a fiberglass material, or any other non-metallic material and/or composite thereof.

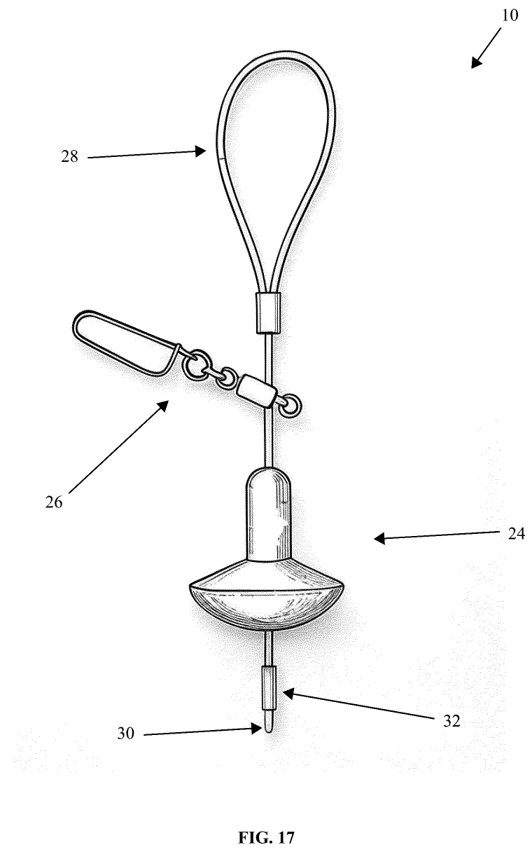

In the arrangement shown, as one example, decoy 20 may have a connection member such as, by way of example and not limitation, an eye bolt, loop, or any other connection member, which can be seen in FIG. 17. In the arrangement shown, as one example, the first end 28 of rig line 22 may be extended through the connection member of decoy 20 and, once extended through the connection member of decoy 20, tied or otherwise formed into a loop, thereby securing the first end 28 of rig line 22 to decoy 20. While first end 28 of rig line 22 may be connected to decoy 20 in this way, first end 28 of rig line 22 may be connected to decoy 20 through any other means of connection.

In the arrangement shown, as one example, rig line 22 extends down from first end 28, connected to decoy 20, towards the second end 30 of rig line 22. As rig line 22 extends down, it passes through the aperture 46 of rig 24 and the second end 30 of rig line 22 extends outward from the bottom side 38 of rig 24. In the arrangement shown, as one example, rig line 22 includes a stopper 32 at the second end 30 of rig line 22.

Stopper 32 is formed of any suitable size, shape, and design and is configured to prevent rig line 22 from passing back through the rig 24, which would result in the rig 24 being disconnected from rig line 22 and decoy 20. In the arrangement shown in FIG. 17, as one example, once second end 30 of rig line 22 is extended through rig 24, stopper 32 is then placed onto second end 30, thereby securely connecting rig line 22 to rig 24. In the arrangement shown, as one example, stopper 32 is an oval stop sleeve, however any other type or configuration of stopper or other member may be used in order to stop the second end 30 of rig line 22 from passing back through rig 24. In one or more alternative arrangements, as examples, stopper 32 may simply be a knot or loop in rig line 22 which is wider than the aperture 46 of rig 24, thereby preventing the second end 30 of rig line 22 from entering and passing back through aperture 46 of rig 24.

While rig line 22 and its components have been described according to the arrangement shown, as one example, it will be understood by those skilled in the art that any other configuration of rig line 22 and its components may be used in order to operably connect decoy 20 and rig 24.

### Rig 24

In the arrangement shown, as one example, system 10 includes rig 24. Rig 24 is formed of any suitable size, shape, and design and is configured to provide an anchor to keep decoy 20 in place when in use. In the arrangement shown, as one example, rig 24 is a mushroom weight, however any other shape, type, configuration, or version of a weight of decoy rigging system weight may be used as rig 24. In the arrangement shown, as one example, rig 24 includes a top side 36, a bottom side 38, a stem portion 42, a base portion 44, and an aperture 46.

In the arrangement shown, as one example, rig 24 is formed of a single, unitary member that is formed in a manufacturing process such as casting, molding, machining, additive manufacturing, or the like. Alternatively, rig 24 may be formed of multiple pieces that are connected or assembled to one another through any means of connecting or assembling the multiple pieces such as welding, bolting, screwing, adhesion, or the like. In the arrangement shown, as one example, rig 24 is formed primarily of a metallic material such as steel, aluminum, chromium, or any other metallic material, alloy, and/or composite thereof. Alternatively, rig 24 may be formed of a non-metallic material such as a plastic material, a fiberglass material, or any other non-metallic material and/or composite thereof.

In the arrangement shown, as one example, rig 24 extends in a mushroom shape from a top side 36 to a bottom side 38. In one or more arrangements, as one example, top side 36 is generally rounded in shape. In one or more arrangements, as one example, top side 36 is semi-spherical in shape. In the arrangement shown, as one example, the top portion forms a stem portion 42 of rig 24. In the arrangement shown, as one example, stem portion 42 extends downward from top side 36 of rig 24. In the arrangement shown, as one example, stem portion 42 has an exterior surface 48 which extends around the outside of stem portion 42. In the arrangement shown, as one example, stem portion 42 extends downward to bottom end 50 of stem portion 42.

In the arrangement shown, as one example, the mushroom shape of rig 24 may be configured to provide enhanced stability and control of the decoy 20 in a variety of water conditions. For example, the broad, rounded profile of rig 24 may allow the rig 24 to settle more predictably in the water or on the bottom, thereby improving placement accuracy and maintaining the decoy 20 in a desired position.

In one or more arrangements, as examples, stem portion 42 is a generally cylindrical member which extends downward from top side 36. In one or more arrangements, as one example, the stem portion 42 may have a slight angle outward as it moves downward from the top side 36. In one or more arrangements, as one example, stem portion 42 may be partially cone-shaped.

In the arrangement shown, as one example, the bottom end 50 of stem portion 42 connects to the top surface 52 of base portion 44. In the arrangement shown, as one example, base portion 44 extends outward from the bottom end 50 of stem potion 42 to provide a wide base for rig 24. In the arrangement shown, as one example, the extension outward of base portion

44 forms the top surface 52 of base portion 44. In one or more arrangements, as one example, top surface 52 of base portion 44 may have a slight angle downward as it extends a distance outward from the bottom end 50 of stem portion 42. In the arrangement shown, as one example, base portion 44 also includes an exterior surface 54 extending around the outside of base portion 44.

In one or more arrangements, as one example, the exterior surface 54 of base portion 44 curves downward and inward towards the middle of rig 24 as it moves toward the bottom side 38 of rig 24. In one or more arrangements, as one example, base portion 44 of rig 24 is generally rounded. In one or more arrangements, as one example, base portion 44 is semi-spherical.

In the arrangement shown, as one example, the configuration of stem portion 42 and base portion 44 gives rig 24 a shape which resembles a mushroom turned upside down.

In the arrangement shown, as one example, rig 24 includes aperture 46. Aperture 46 is formed of any suitable size, shape, and design and is configured to extend vertically through rig 24 and allow rig line 22 to pass through rig 24. In the arrangement shown, as one example, aperture 46 is a generally cylindrical shaped absence of material which passes vertically through the middle of rig 24 from the top side 36 to bottom side 38 of rig 24.

In one or more arrangements, as one example, aperture 46 may be formed after the general shape of rig 24 is formed by machining away material from rig 24 to form aperture 46. In one or more alternative arrangements, as one example, aperture 46 may be formed during a manufacturing process such as casting by using a core to create aperture 46 during the casting process.

While rig 24 and its components have been described according to the arrangement shown, as one example, it will be understood by those skilled in the art that any other configuration of rig 24 and its components may be used in order to provide an anchor to keep decoy 20 in place when in use.

### Swivel 26

In the arrangement shown, as one example, system 10 includes one or more swivels 26. Swivel 26 is formed of any suitable size, shape, and design and is configured to be operably connected to rig line 22 to facilitate smooth operation of system 10. In the arrangement shown, as one example, swivel 26 may be positioned at any suitable location along the rig line 22, including adjacent the decoy 20, adjacent the rig 24, or at an intermediate point along rig line 22. The swivel 26 may be provided as a single-axis or multi-axis rotational connector configured to permit relative rotation between portions of the rig line 22.

In the arrangement shown, as one example, swivel 26 may reduce twisting, tangling, or fouling of the rig line 22 during deployment, retrieval, or storage of the decoy 20. For example, when the decoy 20 rotates on the water surface due to wind or water waves, the swivel 26 may allow the decoy 20 to rotate freely without imparting torsional forces to the remainder of the rig line 22. Swivel 26 may also facilitate ease of handling when the rig line 22 and rig 24 are wrapped or bundled for transport.

In some arrangements, as one example, the swivel 26 may form part of a Texas-rig style assembly, such as by being disposed between a snap, clip, or loop and a segment of monofilament, coated cable, or other line material. In the arrangement shown, as one example, swivel 26 is formed primarily of a metallic material such as steel, aluminum, chromium, or any other metallic material, alloy, and/or composite thereof. Alternatively, swivel 26 may be formed of a non-metallic material such as a plastic material, a fiberglass material, or any other non-metallic material and/or composite thereof. Swivel 26 may be sized or rated to withstand expected loads encountered during normal use. In alternate arrangements, as one example, swivel 26 may optionally include bearings, corrosion-resistant coatings, or other features to enhance durability in marine or wetland environments.

Use of swivel 26 is optional, and system 10 may be configured with or without one depending on user preference or intended operating conditions.

### In Operation

In various arrangements, system 10 may be used to attract waterfowl that are being hunted. In various arrangements, system 10 may be set up by identifying the spot where system 10 will be used, which for waterfowl is typically in shallow waters. In the arrangement shown, as one example, the user must connect the decoy 20, rig line 22, and rig 24 together.

In order to do so, in one or more arrangements the user must thread the first end 28 of rig line 22 through and/or into the connection member of decoy 20. In one or more arrangements, the user must then tie the first end 28 of rig line 22 into a knot, place a stopper on first end 28, or otherwise close off first end 28 of rig line 22 so that it may not slip off of the connection member of decoy 20. In one or more arrangements, the user must then connect rig line 22 to rig 24 by threading the second end 30 of rig line 22 through the aperture 46 of rig 24 starting at the top side 36 and going until second end 30 of rig line 22 extends outward from bottom side 38 of rig 24. Once the second end 30 of rig line 22 extends outward from the bottom side 38 of rig 24, a stopper 32 is then placed on second end 30, thereby preventing second end 30 from slipping back through aperture 46. In the alternative, the user may connect multiple portions of rig line 22 to a swivel 26, as desired, during setup of system 10.

In one or more arrangements, once the rig line 22 is operably connected to rig 24 and extended through the aperture 46 of rig 24, rig 24 is free to quickly and easily slide along the length of rig line 22. That is, with rig line 22 extended through the aperture 46 of rig 24, rig 24 can slide along the length of rig line 22, from first end 28 to second end 30 of rig line 22, and is prevented from becoming disconnected from rig line 22 due to stopper 32 on the second end 30 of rig line 22 and decoy 20 on the first end 28 of rig line 22. This configuration of rig 24 with the aperture 46 extending through the entirety of rig 24 from top side 36 to bottom side 38 of rig 24 provides for easier, faster, more efficient, and snag-free movement of rig 24 along the entirety of rig line 22.

In one or more arrangements, as one example, once decoy 20, rig line 22, and rig 24 are all operably connected, the user may place decoy 20 in a desired position and then allow rig 24 to slide down along rig line 22 until it meets the bottom of the body of water that decoy 20 is positioned on. Once rig 24 is at the bottom of the body of water, rig 24 anchors or otherwise weighs down decoy 20 such that decoy 20 stays at the desired position, even when decoy 20 is being used in high wind and/or wave conditions.

From the above discussion it will be appreciated that the decoy rigging system 10 presented herein improves upon the state of the art. Specifically, in one or more arrangements, a decoy riggings system 10 is presented which: improves upon the state of the art; is safe to operate; is relatively easy to build; is relatively friendly to build; can be built relatively quickly and efficiently; is easy to operate; is relatively cost friendly to manufacture; is relatively easy to transport; is aesthetically appealing; is robust; is relatively inexpensive; is not easily susceptible to wear and tear; has a long useful life; is efficient to use and operate.

What is claimed

1. A decoy rigging system, comprising:
a decoy;
a rig line;
a rig;
the rig having a stem portion and a base portion;
the rig having an aperture extending vertically through the stem portion and the base portion;
wherein the rig line is operably connected to the decoy;
wherein the rig line extends through the aperture of the rig thereby operably connecting to the rig; and
wherein the rig prevents the decoy from moving when the decoy is in use.

2. The system of claim 1, wherein the base portion of the rig is rounded.

3. The system of claim 1, wherein the base portion is semi-spherical in shape.

4. The system of claim 1, wherein the base portion includes a top surface which extends at an angle downward and outward from the stem portion.

5. The system of claim 1, wherein the stem portion is partially cone-shaped.

6. The system of claim 1, wherein the stem portion is primarily cylindrical in shape.

7. The system of claim 1, wherein the stem portion extends at an angle outward and downward as it moves from a top side of the rig to the base portion.

8. The system of claim 1, wherein a top side of the rig is rounded.

9. The system of claim 1, wherein a top side of the rig is semi-spherical in shape.

10. The system of claim 1, wherein the rig line further comprises a loop to facilitate connection to the decoy.

11. A decoy rigging system, comprising:
a decoy;
a rig line;
the rig line having a first end and a second end;
the rig line having a stopper at the second end of the rig line;
a rig;
the rig having a top side and a bottom side;
the rig having an aperture extending vertically through the rig from the top side to the bottom side;
wherein the first end of the rig line is operably connected to the decoy;
wherein the second end of the rig line extends through the aperture and outward from the bottom side of the rig;
wherein the stopper at the second end of the rig line prevents the rig line and the rig from becoming disconnected; and
wherein the rig prevents the decoy from moving when the decoy is in use.

12. The system of claim 11, wherein the rig includes a base portion near the bottom side of the rig and wherein the base portion is rounded.

13. The system of claim 11, wherein the rig includes a base portion near the bottom side of the rig and wherein the base portion is semi-spherical in shape.

14. The system of claim 11, wherein the rig includes a base portion near the bottom side of the rig and wherein the base portion includes a top surface which extends at an angle downward and outward from a stem portion of the rig.

15. The system of claim 11, wherein the rig includes a stem portion near the top side of the rig and wherein the stem portion is partially cone-shaped.

16. The system of claim 11, wherein the rig includes a stem portion near the top side of the rig and wherein the stem portion is primarily cylindrical in shape.

17. The system of claim 11, wherein the rig includes a stem portion near the top side of the rig and wherein the stem portion extends at an angle outward and downward as it moves from the top side of the rig to the bottom side of the rig.

18. The system of claim 11, wherein the top side of the rig is rounded.

19. The system of claim 11, wherein the top side of the rig is semi-spherical in shape.

20. The system of claim 11, wherein the first end of the rig line further comprises a loop to facilitate connection to the decoy.

21. A decoy rigging system, comprising:
a rig line;
the rig line having a first end and a second end;
the first end configured to connect to a decoy;
the second end having a stopper;
a mushroom shaped rig;
the mushroom shaped rig having a top side and a bottom side;
the mushroom shaped rig having a base portion near the bottom side;
the mushroom shaped rig having a stem portion near the top side;
wherein the stem portion has a first diameter;
where the base portion has a second diameter;
wherein the second diameter is greater than the first diameter; and
wherein the mushroom shaped rig has an aperture that extends through the approximate center of the mushroom shaped rig from the top side to the bottom side of the mushroom shaped rig.

22. The system of claim 21, wherein the rig line extends through the aperture of the mushroom shaped rig.

23. The system of claim 21, wherein the base portion of the rig is rounded.

24. The system of claim 21, wherein the base portion is semi-spherical in shape.

25. The system of claim 21, wherein the base portion includes a top surface which extends at an angle downward and outward from the stem portion.

26. The system of claim 21, wherein the stem portion is partially cone-shaped.

27. The system of claim 21, wherein the stem portion is primarily cylindrical in shape.

28. The system of claim 21, wherein the stem portion extends at an angle outward and downward as it moves from the top side of the rig to the base portion.

29. The system of claim 21, wherein the top side of the rig is rounded.

30. The system of claim 21, wherein the top side of the rig is semi-spherical in shape.
